(19) United States
(12) Patent Application Publication
(10) Pub. No.: US 2026/0367573 A1
(43) Pub. Date: Nov. 19, 2026

(54) METHOD FOR DECORATING A TIMEPIECE COMPONENT

(71) Applicant: Montres Breguet S.A., L'Abbaye (CH)

(72) Inventors: Dave MANGIN, Le Sentier (CH); Sébastien MAIRE, Villards d’Héria (FR); Yoanne BESSON, Houtaud (FR)

(73) Assignee: Montres Breguet S.A., L'Abbaye (CH)

(21) Appl. No.: 19/651,941

(22) Filed: Apr. 20, 2026

(30) Foreign Application Priority Data
May 15, 2025 (EP) 25176832.1

(51) Int. Cl. G04B 19/10; G04D 3/02

(52) U.S. Cl. CPC G04B 19/10; G04D 3/02

(57) ABSTRACT

A method for decorating a timepiece component, including: providing a component (1) having an outer face (10) and an inner face (11); machining the component (1) over a given height on the inner face and/or on the outer face to form a cavity (6, 6') forming at least one zone to be decorated, with a first flange (2) on the periphery thereof; piercing the component in the zone to form a through hole; decorating the entire surface (20) of the zone in the cavity (6, 6’) by mechanically removing material; fastening the element (5, 5') with a complementary shape in the through hole (4, 4') to form a second flange (3), the first and second flanges (2, 3) defining a volume; and depositing a layer of translucent enamel (21) in the volume defined by the first and second flanges (2, 3).

### CROSS-REFERENCE TO RELATED APPLICATIONS

This application claims priority to European Patent Application No. 25176832.1, filed on May 15, 2025, the entire contents of which are incorporated herein by reference.

### TECHNICAL FIELD OF THE INVENTION

The present invention relates to the field of horology and more specifically to a method for decorating a timepiece component.

### TECHNOLOGICAL BACKGROUND

Decoration by mechanical removal of material consists of forming engravings on a plate, namely designs composed of lines or curves that may or may not intersect or intertwine, often symmetrically, to achieve a decorative effect. The patterns that can be created can vary considerably. While it is now possible to create decorations using digitally controlled machines, conventional methods require complex machines that control the movements of the object to be decorated and of the chisels by actuating cams and slides. These operations are generally carried out on parts with flat or cylindrical faces.

Components decorated in this way can be enhanced with a translucent enamel that is virtually unalterable.

This type of component not only has a virtually infinite lifespan with no alteration, but also lends a very special appearance to the watch, particularly in terms of decoration.

However, one of the drawbacks of such a component is that edges or flanges must be formed on the outer and inner sides of the component to define a volume in which to deposit an enamel layer with straight rims. In fact, it is necessary to cloisonné the enamel to avoid any depression that could lead to a dome. However, these edges make it impossible to apply rim-to-rim decoration to the entire decorated surface of the component, particularly in the immediate vicinity of any of the edges.

### SUMMARY OF THE INVENTION

The invention aims in particular to remedy the various drawbacks of components thus decorated in the prior art.

More specifically, the invention aims to provide a component that is decorated and enamelled over the entire decorated surface delimited by the edges.

To this end, the invention relates to a method for decorating a timepiece component, comprising the following steps:
a) providing a component, the component having an outer face and an inner face;
b) machining the component over a given height on the inner face and/or on the outer face to form at least one cavity forming at least one zone to be decorated, with a first flange on the periphery of the at least one zone to be decorated on the component;
c) piercing the component in the at least one zone to be decorated to form at least one through hole;
d) decorating the entire surface of the at least one zone to be decorated in the at least one cavity by mechanically removing material; -
e) fastening an element with a complementary shape in the hole to form a second flange, the first and second flanges defining a volume;
f) depositing a layer of translucent enamel in the volume defined by the two flanges.

According to other advantageous variants of the invention:
the component is made of metal, a metallic alloy, ceramic or sapphire;
the enamel layer has a thickness greater than or equal to the height of the first and second flanges;
the at least one element with a complementary shape is made of metal, metal alloy or ceramic;
the at least one element with a complementary shape has a height greater than or equal to the height of the component;
the decoration by mechanical removal of material is chosen among: engine turning, satin-finishing, cotes de Genève, sunray brushing, snailing, engraving, chasing, grinding, shot-blasting, sandblasting;
the component is a dial, a bezel, a plate, a bar, an oscillating mass, a middle, a barrel, a back or a flange.

The invention also relates to a timepiece comprising a component obtained according to the method described in the invention.

### BRIEF DESCRIPTION OF THE FIGURES

Other features and advantages of the invention will become apparent from the following detailed description, given by way of non-limiting example, with reference to the attached drawings in which:

FIG. 1 illustrates the various steps in the method according to the invention;

FIG. 2 shows a cross-sectional view of a component produced according to the method described in the invention;

FIG. 3 illustrates a top view of a dial produced using the method according to the invention.

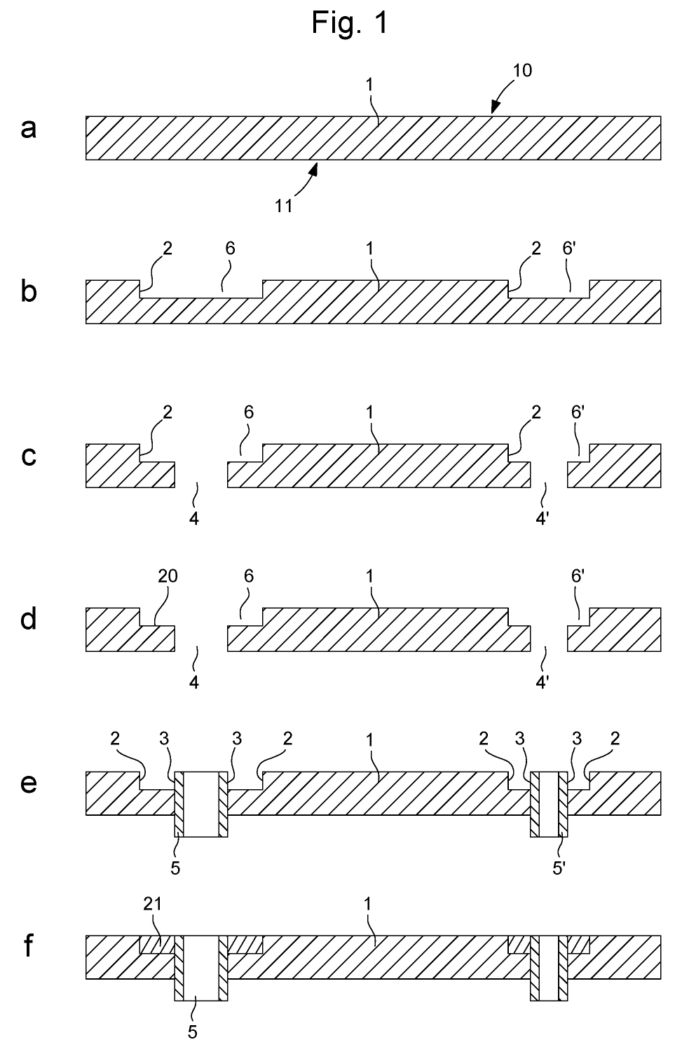

### DETAILED DESCRIPTION OF THE INVENTION

An exemplary embodiment of the invention used to decorate a dial 1 is described below. This example is provided for illustrative and non-limiting purposes only. Other components such as a bezel, a plate, a bar, an oscillating weight, a middle, a barrel, a back or a flange can be decorated using the method according to the invention.

As illustrated in FIG. 3, the visible outer face 10 of the dial 1 is the one displayed to the wearer of the timepiece. The dial 1 has a decoration 20 and an enamel 21 on its outer face delimited by first and second dial flanges 2, 3, the decoration 20 extending from the base of one flange to the base of the other flange.

The dial 1 is a metallic dial, made of a metallic alloy, for example gold, silver, steel or copper, ceramic or even sapphire.

Any type of decoration 20 can be created by mechanically removing material, such as repeating geometric patterns, curves or lines. For example, the decoration by mechanical removal of material is chosen among: engine turning, satin-finishing, cotes de Genève, sunray brushing, snailing, engraving, chasing, grinding, shot-blasting, sandblasting.

The visible outer face also comprises an enamel layer 21 deposited on the decorated outer face in a volume formed by the first and second flanges 2, 3. The enamel layer is translucent so that the decoration on the dial 1 can be observed.

Dial indexes and/or patterns can be transferred, painted or enamelled onto the enamel layer 21. Numbers, affixed letters, appliques and logos can also be applied to the dial 1.

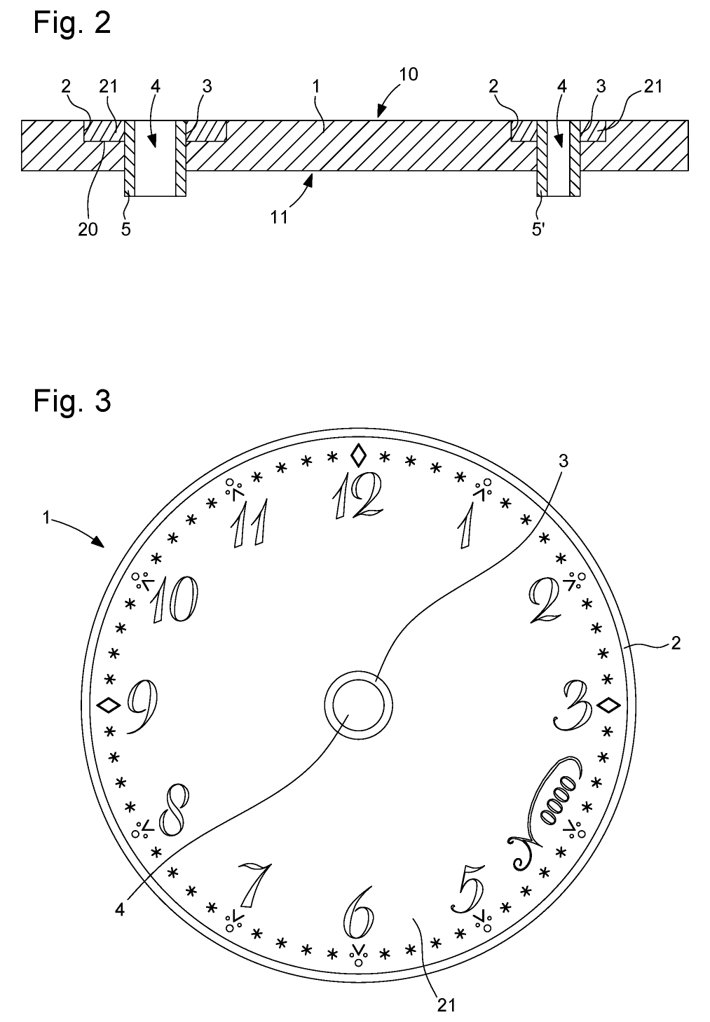

FIG. 2 shows a cross-section of a horology component 1 decorated according to the method described in the invention. The component 1 comprises a first cavity 6 and a second cavity 6' to be decorated, each of the cavities 6, 6' comprising a first through hole 4 and a second through hole 4' each receiving a first tube 5 and a second tube 5'. Such 5.5' tubes make it possible, for example, to accommodate arbors or the feet of appliques. The tube or tubes 5,5' are driven in the holes 4,4', the tubes forming the second flange 3. Tubes can also be riveted, soldered or brazed.

The method for producing a horology component 1 according to the invention will now be described.

In a first step a), a component 1 is provided, the component having an outer face 10 and an inner face 11. The component is made of a metal such as gold, silver, titanium, palladium or even copper, for example. A metallic alloy can also be used.

In the second step b), the ebauche is machined to a specific height on the outer face 10 and on the inner face 11 to form at least one cavity 6 forming a zone to be decorated with a first flange 2. As illustrated, the component comprises a second cavity 6' forming a second zone to be decorated. The component 1 can of course comprise several cavities according to the needs of the person skilled in the art.

In the third step c), at least a first hole 4 is pierced in the first cavity of the ebauche, and a second hole 4' is pierced in the second cavity 6'.

In the fourth step d), a decoration 20 is made by mechanically removing material from the entire surface of the zone to be decorated in the at least one cavity 6, 6' from the first flange 2 to form at least one decorated zone.

In the fifth step e), an element 5 with a complementary shape is fastened in the first hole 4, and a second element 5' with a complementary shape is fastened in the second hole 4' to form a second flange 3 within each of the cavities 6, 6'. The first and second flanges 2, 3 thus make it possible to define a volume suitable for receiving an enamel.

The element with the complementary form is preferably metallic, or made of a metallic alloy, and preferably identical to that of the component.

In the sixth step f), a translucent enamel layer 21 is deposited on the decorated zone 20 of the component in the volume defined by the first and second flanges 2, 3.

Conventionally, the enamel is initially in the form of a powder which, when mixed with water, forms a paste that can be spread on the face of the dial. The enamel is then baked in an oven to solidify.

After this step f), the deposited enamel layer can optionally be polished.

It is also possible to carry out the final manufacturing operations, such as affixing appliques or decals, to obtain a component 10 ready to be fitted in a timepiece.

These various aspects of the invention ensure that there is a decorative, enamelled component over the entire surface of the desired zones to be decorated.

1. A method for decorating a timepiece component, comprising the following steps:
providing a component (1), the component having an outer face (10) and an inner face (11);
machining the component (1) over a given height on the inner face and/or on the outer face to form at least one cavity (6, 6') forming at least one zone to be decorated, with a first flange (2) on the periphery of the at least one zone to be decorated on the component;
piercing the component in the at least one zone to be decorated to form at least one through hole (4, 4');
decorating the entire surface (20) of the zone to be decorated in the at least one cavity (6, 6’) by mechanically removing material;
fastening at least one element (5, 5') with a complementary shape in the at least one through hole (4, 4') to form a second flange (3), the first and second flanges (2, 3) defining a volume;
depositing a layer of translucent enamel (21) in the volume defined by the first and second flanges (2, 3).

2. The method according to claim 1, characterised in that the component (1) is made of metal, a metallic alloy, ceramic or sapphire.

3. The method according to claim 1, in which the enamel layer (21) has a thickness greater than or equal to the height of the first and second flanges (2, 3).

4. The method according to claim 1, in which the at least one element with a complementary shape (5, 5') is made of metal, metal alloy or ceramic.

5. The method according to claim 1, in which the at least one element with a complementary shape (5, 5') has a height greater than or equal to the height of the component.

6. The method according to claim 1, in which the decoration by mechanical removal of material is chosen among: engine turning, satin-finishing, cotes de Genève, sunray brushing, snailing, engraving, chasing, grinding, shot-blasting, sandblasting.

7. The method according to claim 1, in which the component (1) is a dial, a bezel, a plate, a bar, an oscillating mass, a middle, a barrel, a back or a flange.

8. A timepiece comprising a component (1) produced by the method according to claim 1.
